(19) United States
(12) Patent Application Publication
(10) Pub. No.: US 2025/0000194 A1
(43) Pub. Date: Jan. 2, 2025

(54) IMPACT PROTECTION STRUCTURE

(71) Applicant: McMaster University, Hamilton (CA)

(72) Inventors: Hiu Ming Yu, Victoria (CA); Cheryl Quenneville, Hamilton (CA); Annie King, Kingston (CA); Hatem Zurob, Hamilton (CA)

(21) Appl. No.: 18/756,668

(22) Filed: Jun. 27, 2024

Related U.S. Application Data
(60) Provisional application No. 63/523,498, filed on Jun. 27, 2023.

(51) Int. Cl. A42B 3/12; F16F 1/374; F16F 1/377

(52) U.S. Cl. CPC A42B 3/12; F16F 1/374; F16F 1/377

(57) ABSTRACT

An impact protection structure, including a sheet formed of a plurality of polygonal cells adjacent one another, the plurality of polygonal cells including a plurality of hexagonal cells, the plurality of polygonal cells including at least one pentagonal cell and at least one heptagonal cell to accommodate a generally domed shape in the sheet with a reduction in a distortion of a regular shape of the plurality of hexagonal cells.

### CROSS REFERENCE TO RELATED APPLICATION

This application claims the benefit of U.S. Provisional Patent Application No. 63/523,498, filed Jun. 27, 2024, the entirety of which is hereby incorporated by reference herein.

### FIELD

The description relates generally to impact protection, particularly to structures for impact protection.

### BACKGROUND

Head injuries can be caused by two distinct types of threat, with two different orientations of impact force: direct impact with high normal contact force that can cause skull fracture, and oblique impact with lower contact force but higher rotational component (i.e. speed and acceleration) that can cause mild traumatic brain injuries, such as concussions.

For example, bicycling is a popular activity around the world as a form of exercise and means of transportation. Although bicycling provides health benefits, it is also a frequent source of injury. By some estimates, over 600,000 individuals are treated in emergency rooms in the United States for bicycle-related injuries each year. Of these, about 30% involve head injuries, which include skull fracture, facial fracture, and traumatic brain injury (TBI). Further, head injuries are the most common cause of death in bicycle-related accidents. Traumatic brain injury is one of the leading causes of disability around the world and contributes to approximately 30% of all injury deaths. Head injuries in these events are often caused by blunt impacts, which are typically oblique with respect to the impact surface, where radial and tangential force components are induced. The oblique impact force is made up of a radial force component that induces linear head kinematics, and a tangential force component that induces rotational head kinematics. Both the contact forces and the resulting inertial forces on the head are common injury mechanisms.

Skull fractures are caused by the radial force component of an impact causing stress to the cranial bone at the point of impact that exceeds its strength and are present in 45-58% of patients admitted to the hospital following an accident that occurred while riding a bicycle. The risk of enduring a skull fracture is typically measured according to peak linear acceleration, as this metric correlates with the level of stress on the skull. There is also evidence that rotational motion can be the cause of focal injuries such as subdural hematoma, intracerebral hematoma, and cerebral contusions. Due to the brain's susceptibility to strain from shear loading, rotational acceleration is the most likely injury predictor. Based on this, the most effective way to prevent skull fracture and hematoma/contusion secondary to skull fracture would therefore be to minimize the magnitudes of linear acceleration and peak radial impact force. On the other hand, the most effective way to reduce the incidence of concussion, diffuse axonal injury (DAI), and some hematoma and contusion cases would be to minimize the magnitudes of rotational kinematics caused by the tangential force component of an impact.

Some bicycle helmets are composed of an outer shell, an energy-absorbing layer, and a strap/retention system. The outer shell may be made from polycarbonate to protect the head from penetration by sharp objects, as well as to distribute impact force over a larger surface area. The energy-absorbing layer may be made from expanded polystyrene (EPS) foam. The impact force is transmitted to the EPS foam layer from the polycarbonate shell, and energy not absorbed by the foam is then transmitted to the head and may pose a risk of injury. Since both radial and tangential force components contribute to the risk of head injury, energy absorption in both the compressive and shear loading directions are relevant to studying the effectiveness of helmets. EPS foam is effective in sufficiently reducing contact stress and linear head acceleration and therefore effective in preventing life-threatening injuries. On the other hand, EPS foam helmets have not been designed to prevent many types of TBI, such as concussion and diffuse axonal injury. The limitations of traditional helmets to protect the head in rotation are attributed to the mechanical response of the material-EPS foam does not sufficiently deform under shear loading to address rotational accelerations. Shear stress not absorbed by the helmet or other mechanisms, such as sliding of the helmet on the head, is transferred to the head in the form of rotational acceleration.

EPS foam helmets absorb the impact energy and thus effectively reduce the risk of skull fracture, penetrating injury, and severe brain injury from a direct impact. However, in contrast to standard lab tests (such as drop towers), impacts in real-world bicycle accidents typically occur at an angle with respect to the horizontal surface. Since EPS foams are 3D isotropic materials (i.e. with the same stiffness and strength in all directions), they are unable to shear or slide in a tangential direction and thus cause a high rotational acceleration of the head during the impact. Therefore, helmets made of EPS foam alone (i.e. without additional rotational damping mechanism) are ineffective in protecting against mild traumatic brain injuries such as concussions.

Furthermore, EPS is a sacrificial energy absorber that plastically deforms during impact and is permanently damaged after crushing. As a result, the effectiveness is immediately compromised after any impact, even if the helmet does not visually appear to be damaged and a user might think it can still provide protection in the future.

Due to these properties, EPS foam helmets have drawbacks in that they offer only one type of protection (i.e., preventing skull fracture from direct impact only) and they are not reusable after even mild levels of impact. This ultimately jeopardizes the safety of the user.

To offer protection against both direct and oblique impacts, newer generations of helmets have been designed. However, two design styles currently produced both suffer from their own design drawbacks that limit their performance.

A first group of designs add a slidable layer of plastic sheet or elastomer. For example, bicycle helmets with dedicated rotation-damping systems aim to mitigate shear stress transferred to the head by accommodating shear deformation themselves, while still protecting against radial contact forces. An example is the Multidirectional Impact Protection System™ (MIPS™) (Täby, Sweden) slip liner. This thin polycarbonate plastic liner reduces the rotational acceleration of the head upon impact by permitting 10-15 mm of movement between the helmet and the head via a low-friction interface with an EPS foam layer. WaveCel™ (Wilsonville, Oregon, USA) helmets contain a plastic cellular structure in addition to the EPS foam component, that acts to mitigate rotational kinematics.

Although MIPS, WaveCel, and HEXR all improve upon EPS foam helmets in terms of mitigation of rotational kinematics, the risk of injury could be further reduced with future helmet technologies. Due to the limitations of EPS foam, it is hypothesized that a design with an alternate material than EPS foam altogether, such as in the HEXR helmet, would be beneficial. It is worth noting that the HEXR's honeycomb structure includes disconnected cells, which may affect the impact attenuation capability in these areas. Finally, the above helmets absorb impact energy through plastic deformation, making them ‘single-use’ but despite this, people don't always discard their equipment after a light or moderate impact. A helmet design capable of providing protection for multiple impact events would therefore reduce the frequency of head injuries.

A second group of designs (e.g., designs from Smiths™, HEXR™, and 720protections™) utilizes a plurality of cells arranged next to one another. HEXR™ helmets (HEXR™, London, United Kingdom) omit the EPS foam altogether, and are made with a polyamide-11 3D-printed honeycomb-like structure, based on 3D scans of the user's head geometry. However, the HEXR's honeycomb structure includes disconnected cells, which may affect the impact attenuation capability in these areas.

United States Patent Application Publication No. 2021/0282490 A1 purports to disclose an impact protection structure, in particular for a helmet, to absorb kinetic energy during an impact, in particular a fall, comprising a plurality of cells arranged next to one another, wherein each cell has a hollow interior, which is delimited by at least one side wall, wherein cells adjoining one another have at least one common side wall, wherein the interior and the side walls run from an outer side of the impact protection structure to an inner side of the impact protection structure opposing the outer side, wherein at least one side wall of a cell has at least one recess.

Helmets which continue to utilize EPS foams as energy absorbers are not reusable. Furthermore, the sliding action does not absorb a large portion of the oblique energy, but simply delays its application to the user. Finally, these solutions have significantly complicated manufacturing processes. This increases their cost and thus has hindered their widespread adoption.

### SUMMARY

The following summary is intended to introduce the reader to various aspects of the applicant's teaching, but not to define any invention.

According to some aspects, there is provided an impact protection structure, comprising: a sheet formed of a plurality of polygonal cells adjacent one another, the plurality of polygonal cells including a plurality of hexagonal cells, the plurality of polygonal cells including at least one pentagonal cell and at least one heptagonal cell to accommodate a generally domed shape in the sheet with a reduction in a distortion of a regular shape of the plurality of hexagonal cells.

In some examples, the sheet has a first surface and a second surface opposite the first surface, and the polygonal channels each open through the first surface at a first end of the channel and open through the second surface at a second end of the channel.

In some examples, each polygonal channel has a common number of sides at each of the first and second ends of the channel.

In some examples, the sheet includes at least one pentagon-heptagon cell set comprising a pentagonal cell adjacent a heptagonal cell.

In some examples, the plurality of polygonal cells include a plurality of pentagonal cells and a plurality of heptagonal cells, and each of the at least one pentagon-heptagon cell set comprises one or more pentagonal cell and one or more heptagonal cell.

In some examples, the sheet includes a plurality of pentagon-heptagon cell sets separated from one another by hexagonal cells.

In some examples, the pentagonal cells and the heptagonal cells occur in the sheet only in the pentagon-heptagon cell sets.

In some examples, the sheet is an elastomeric sheet.

In some examples, the structure is a single generally domed shape.

In some examples, the impact protection structure is used in a helmet.

In some examples, the plurality of polygonal cells consists of central cells each surrounded by other polygonal cells and edge cells bordering a free edge of the sheet, and the central cells each comprise at least five sides.

In some examples, at least 75% of the central cells are hexagonal cells.

According to some aspects, there is provided an n impact protection structure, comprising: a matrix of a plurality of generally planar sidewall segments joined together at lengthwise ends thereof to form a central portion of a sheet having a first surface and a second surface opposite the first surface, each segment extending from the first surface to the second surface and separating adjacent cells whereby the matrix defines a plurality of polygonal cells adjacent one another, and wherein the plurality of polygonal cells includes a plurality of hexagonal cells and at least one pentagonal cell whereby a generally domed shape in the sheet is accommodated with a reduction in a distortion of a regular shape of the polygonal cells.

In some examples, each sidewall segment has a width between adjacent cells, and the width is generally constant between the first and second surfaces.

In some examples, each sidewall segment has a width between adjacent cells, and the widths of the plurality of generally planar sidewall segments are all generally equal to a common width.

In some examples, each sidewall segment has a width between adjacent cells and the width of each sidewall segment is generally constant along the height of the sidewall segment.

In some examples, each sidewall segment has a length between the ends thereof, and the lengths of the plurality of generally planar sidewall segments are all within a variation of 25% of a predetermined length.

In some examples, the plurality of polygonal cells each have a transverse area at the first surface that is within a variation of 25% of a predetermined area.

In some examples, the plurality of generally planar sidewall segments are formed of an elastomeric material.

In some examples, the impact protection structure is a generally domed shape for use in forming a protective layer in a helmet.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1A is a graph of elastic modulus and sheer moduli over various angles;

FIG. 1B is a top plan view of an example hexagonal cell structure;

FIG. 1C is a top perspective view of the structure of FIG. 1B;

FIG. 2A is a top plan view of an example structure;

FIG. 2B is a top perspective view of a modification of the structure of FIG. 2A;

FIG. 2C is a top perspective view of a second modification of the structure of FIG. 2A;

FIG. 2D is a side perspective view of an example protective structure;

FIG. 3A is a schematic diagram of a radial impact force;

FIG. 3B is a schematic diagram of an oblique impact force;

FIG. 4A is a top perspective view of a small scale test set up;

FIG. 4B is an expanded view of the set up of FIG. 4A;

FIG. 4C is an expanded view of a modified version of the test set up of FIG. 4A;

FIG. 5A is a side perspective view of a model of another protective structure;

FIG. 5B is a side perspective view of a printed sample of the model of FIG. 5A;

FIG. 5C is a helmet incorporating the sample of FIG. 5B;

FIG. 6A is a side perspective view of the helmet of FIG. 5C in a first test set up;

FIG. 6B is a side perspective view of the helmet of FIG. 5C in a second test set up;

FIG. 7A is a first graph showing test results;

FIG. 7B is a second graph showing test results;

FIG. 7C is a third graph showing test results;

FIG. 8A is a fourth graph showing test results;

FIG. 8B is a fifth graph showing test results;

FIG. 9A is a side perspective view of a first position of the helmet of FIG. 5C during a testing operation;

FIG. 9B is a side perspective view of a second position of the helmet of FIG. 5C during a testing operation;

FIG. 10A is a sixth graph showing test results;

FIG. 10B is a seventh graph showing test results; and

FIG. 10C is an eighth graph showing test results.

### DETAILED DESCRIPTION

Various apparatuses or processes will be described below to provide an example of an embodiment of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. It should be noted that the term “coupled” used herein indicates that two elements can be directly coupled to one another or coupled to one another through one or more intermediate elements.

Disclosed herein is a protective structure. The protective structure may be used in, e.g., a helmet (i.e., a protective headgear). In some embodiments, the helmet can protect against both direct and oblique (multi-directional) impacts. In some embodiments, the protective structure has high toughness for head-on direct impacts but can also shear or slide in the tangential direction, e.g., in order to reduce head (and brain) rotation. In some embodiments, the protective structure includes a 2D isotropic (i.e. transversely isotropic) lining material or system, e.g., to have high toughness in the radial direction but high compliance in the tangential plane.

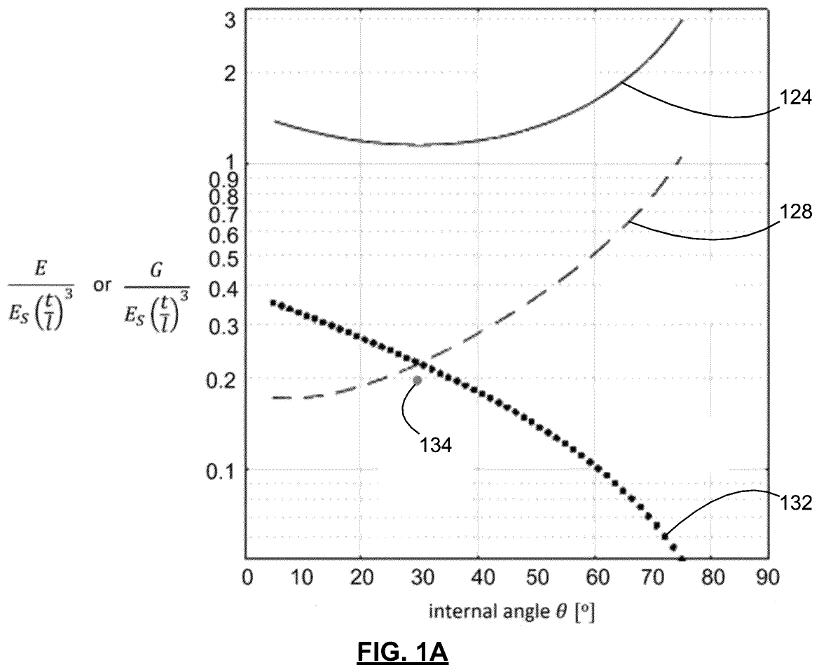

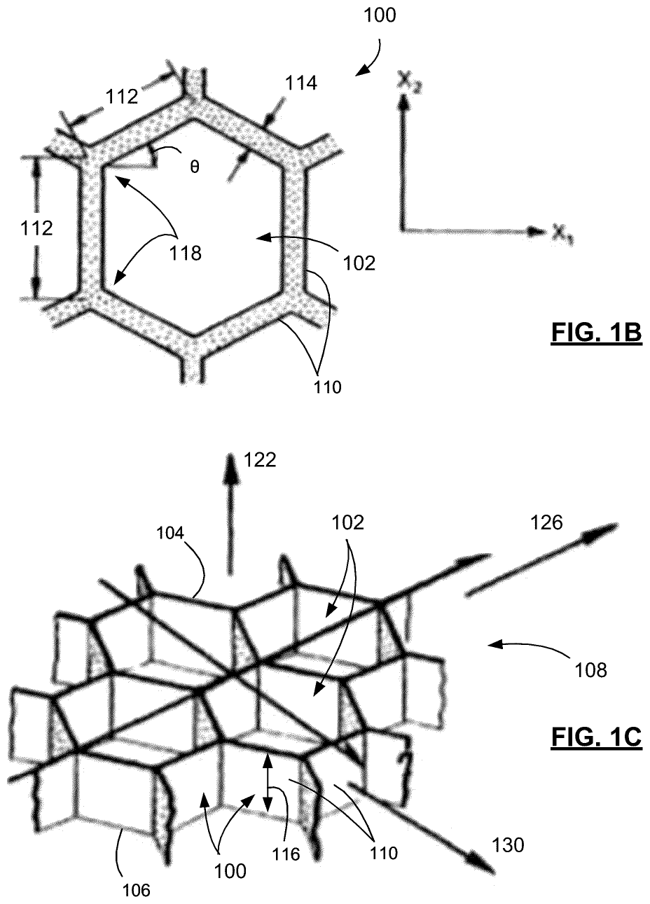

Polymer-based hexagonal honeycomb structure can be used as energy absorbing liners. The honeycomb structure may include a sheet of adjacent unit cells each including a channel extending between opposite surfaces of the sheet and having a polygonal transverse area. An example structure is shown in FIGS. 1B and 1C. The example cell 100 includes a channel 102 extending between a first surface 104 and a second surface 106 of a sheet 108. The cell 100 is formed of wall segments 110. The wall segments meet at ends thereof to form the sheet 108. The wall segments 110 form a matrix whereby separate cells 100 are formed. Each wall segment has a length 112, a width 114, and a height 116. The wall segments meet at corners 118 of a cell 100, and have internal angles θ. A cell 100 with a channel having a hexagonal transverse area may be referred to as a honeycomb cell herein.

The shape of the channel may be generally constant from one end to the other. A honeycomb panel with regular hexagonal unit cells (i.e., a channel having a polygonal transverse area with corners each having an internal angle θ=30°) is a transversely isotropic material. It is tough in the out-of-plane direction and isotopically compliant in the in-plane direction. Such honeycomb structures would be an ideal material to be used as a liner in a bicycle helmet to offer protection against both severe and mild traumatic brain injuries.

However, regular hexagonal unit cells can only fill space on a Euclidean flat plane, whereas a helmet requires an elliptical dome-like surface (e.g., a convex polyhedron). Thus, honeycomb structures of hexagonal unit cells comprise discontinuous or stretched irregular hexagonal unit cells (i.e., θ≠30°). A 15° mismatch in the interior angles in the corners of a channel may be required. The inventors have discovered that a 10° mismatch in the interior angle (i.e., θ=20°-40°) results in a factor of 1.5 shear stiffness mismatch in the orthogonal direction. This causes the honeycomb layer to no longer be transversely isotropic, as exemplified in FIGS. 1A to 1C. FIGS. 1A to 1C illustrate the normalized out-of-plane elastic modulus (E₃₃) and shear moduli (G₂₃ and G₁₃) of a hexagonal honeycomb structure as functions of internal cell angle θ (the Poisson's ratio of the parent solid vs is taken to be 0.3 during the calculation of the shear modulus). FIGS. 1A to 1C illustrate the normalized out-of-plane compressive modules E₃₃ at 122 and a corresponding curve over different angles at 124, the shear modulus G₂₃ at 126 and a corresponding curve over different angles at 128, and a shear modulus G₁₃ at 110 and a corresponding curve over different angles at 132. Regular hexagons include internal angles of 30°, indicated at 134 in FIG. 1A. The abovementioned uneven cell aspect ratio (or cell discontinuity) can lead to unwanted weak points, e.g., in a helmet making it difficult to ensure the same level of safety in all locations of the helmet. Uneven cell aspect ratios that may result in inconsistency of the helmet performance.

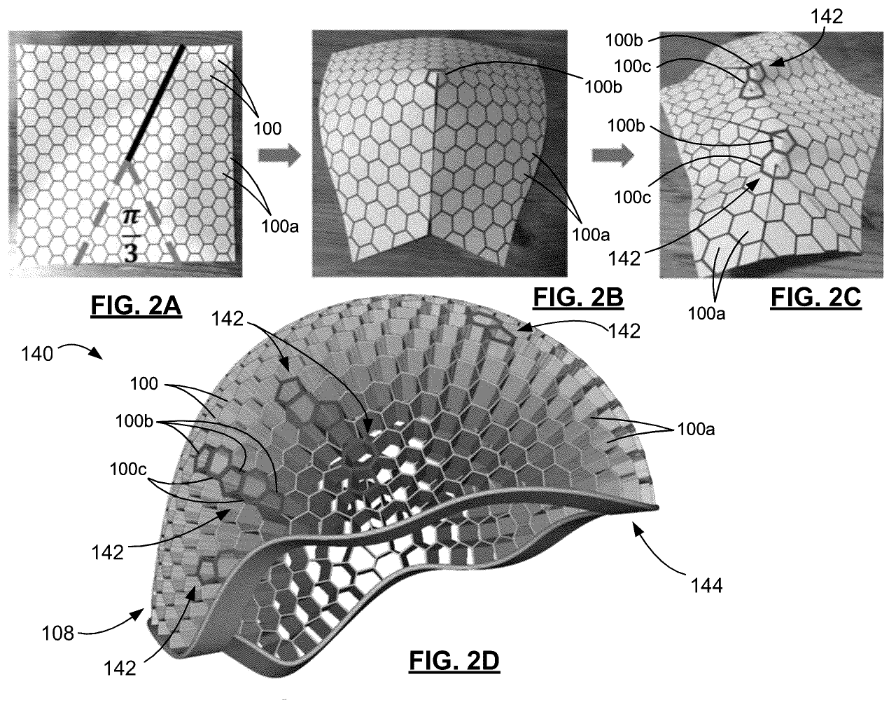

Referring now to FIGS. 2A to 2D, an exemplary protective structure 140 is shown. The protective structure 140 may be used in, e.g., a helmet.

In some embodiments, the protective structure comprises many honeycomb cells because a honeycomb cell is an anisotropic material; it has high toughness in the head-on impact direction, but low shear strength in the oblique direction. Making use of this shape allows a protective structure to offer multi-directional protection against both direct impact that can cause skull fracture and oblique impact that can cause mild traumatic brain injuries such as concussions.

In some embodiments, the protective structure comprises a sheet of adjacent cells formed by a matrix of wall segments to allow the protective structure to be formed of a resilient material, such as an elastomeric material. This may allow the structure to be reusable, such as reusable after impact threats below a certain design limit. In some embodiments, the protective structure comprises a single elastomeric material to simplify manufacturing processes (e.g., in contrast to MIPS™ or WAVECEL™ technology that involves both the use of EPS foams and plastic or elastomeric layers).

In some embodiments, the protective structure includes pentagon cells (5-sided cells) and/or heptagon cells (7-sided cells) at selected locations to allow the structure to be wrapped into a generally domed shape. Panels formed of regular hexagonal honeycomb cells cannot be wrapped into an elliptical dome configuration. In some embodiments, the protective structure includes pentagon-heptagon cell sets each including at least one pentagon cell adjacent at least one heptagon cell (e.g., a pentagon cell and heptagon cell pair). Pentagon-heptagon cell sets create curvature in an otherwise sheet or panel otherwise formed of hexagonal cells. This allows for, e.g., a dome shape. In some embodiments, this maximizes the number of continuous regular hexagonal unit cells in the protective structure. This helps to maximize the transversely isotropic nature of the protective structure and minimize weak spots. In some examples, this novel tiling geometry offers an optimal and predictable level of safety against impact from all angles and to all locations on a protective structure (e.g., a helmet).

The example protective structure 140 of FIG. 2D has a shape that is generally a single dome shape with a free edge 144. The example structure 140 of FIG. 2D is sized and shaped to form a layer (e.g., a liner) of a helmet such as a bicycle helmet. In some embodiments, the protective structure 140 is made from an elastomeric material. In some embodiments, the protective structure 140 consists entirely of a modified honeycomb structure with a topology that accommodates a dome configuration. FIGS. 2A to 2C show an example paper structure in which a curved surface is tiled by introducing pentagons and heptagons to a hexagonal lattice. FIG. 2A shows a sheet of hexagonal cells 100a. FIG. 2B shows a sheet of hexagonal cells 100a and a single pentagonal cell 100b. FIG. 2C shows a sheet of hexagonal cells 100a with pentagonal cells 100b and heptagonal cells 100c. The pentagonal cells 100b and heptagonal cells 100d are arranged in pentagon-heptagon sets 142 (pairs in FIG. 2C). The exemplary sets 142 are separated from one another by hexagonal cells 100a.

FIG. 2D illustrates an example protective structure 140 formed of polygonal cells 100 forming a sheet or panel 108. The polygonal cells 100 of FIG. 2D are primarily hexagonal cells 100a, and the structure includes pentagonal cells 100b and heptagonal cells 100c to accommodate a generally domed shape in the sheet 108 with a reduction in a distortion of a regular shape of the plurality of hexagonal cells 100a. The example dome-like hexagonal-based honeycomb helmet design of FIG. 2D incorporates pentagons and heptagons to accommodate curvature, ensuring that the neighboring hexagonal cells remain nearly regular.

In some embodiments, a protective structure is used in a honeycomb cell-based bicycle helmet design that offers one or more of the following functions: protection in multiple impact directions (both direct and oblique), protection against severe (e.g., skull fracture) and mild (e.g., concussion) traumatic brain injury (TBI), and reusability to protect against multiple impacts.

In some embodiments, e.g., the example shown in FIG. 2D, the entire helmet is made of a dome-like honeycomb panel that consists of numerous polygonal channels. Regular hexagonal honeycomb structures can only conform to zero Gaussian surfaces, such as flat sheets or cylinders. However, by removing one side of a hexagon (by subtracting a π/3 corner), a regular pentagon inclusion is introduced into the hexagonal matrix, which transforms the panel into a positive Gaussian surface like a dome (see paper model in FIG. 2a). Similarly, introducing a regular heptagon into the hexagonal matrix creates a negative Gaussian surface, such as a hyperbolic surface or a minimal surface. As a result, the combination of pentagons and heptagons allows the hexagonal honeycomb panel to conform to any surface with arbitrary Gaussian curvature. The aforementioned tiling technique is used to design dome-like honeycomb cell-based helmets. The majority of the channels consist of regular hexagonal cells, while pentagons and heptagons (5-7 pairs) are introduced to accommodate the helmet's dome-like curvature and minimize distortion in the neighboring hexagonal cells.

In some embodiments, there is provided an elastomeric formed sheet to provide impact protection for a user. In some embodiments, there is provided an elastomeric formed sheet to provide impact protection for a user, used in the construction of protective headgear. In some embodiments, there is provided an elastomeric formed sheet to provide impact protection for a user, used in the construction of protective headgear, employing a honeycomb-like configuration consisting of hexagonal, pentagonal, and heptagonal unit cells to accommodate curvature such that a honeycomb panel can be formed in a dome-like helmet structure. In some embodiments, there is provided an elastomeric formed sheet to provide impact protection for a user, used in the construction of protective headgear, employing a honeycomb-like configuration consisting of hexagonal, pentagonal, and heptagonal unit cells to accommodate curvature such that a honeycomb panel can be formed in a dome-like helmet structure, wherein the introduction of pentagons and heptagons will minimize distortion in hexagonal unit cells and suppress locations of mechanical weakness. In some embodiments, there is provided an elastomeric formed sheet to provide impact protection for a user, used in the construction of protective headgear, employing a honeycomb-like configuration consisting of hexagonal, pentagonal, and heptagonal unit cells to accommodate curvature such that a honeycomb panel can be formed in a dome-like helmet structure, causing the helmet to have high toughness in the radial direction and lower shear strength and stiffness in tangential directions; allowing the helmet to absorb energy for head-on direct impacts and allowing it to shear to protect against rotation in the oblique direction. In some embodiments, there is provided an elastomeric formed sheet to provide impact protection for a user, used in the construction of protective headgear, employing a honeycomb-like configuration consisting of hexagonal, pentagonal, and heptagonal unit cells to accommodate curvature such that a honeycomb panel can be formed in a dome-like helmet structure, causing the helmet to have high toughness in the radial direction and lower shear strength and stiffness in tangential directions; allowing the helmet to absorb energy for head-on direct impacts and allowing it to shear to protect against rotation in the oblique direction, allowing the headgear to provide protection against both severe and mild concussions. In some embodiments, there is provided an elastomeric formed sheet to provide impact protection for a user, used in the construction of protective headgear, wherein the bulk material of the helmet is chosen to be an elastomer.

A drop tower test setup may be used for standardized helmet testing and advanced helmet testing involving an oblique impact surface. In oblique tests, helmets may be evaluated based on the linear and rotational kinematics of an anthropomorphic test device (ATD) headform following impact. Oblique drop tower testing is a combined loading scenario, transmitting both compressive and shear forces to the helmet.

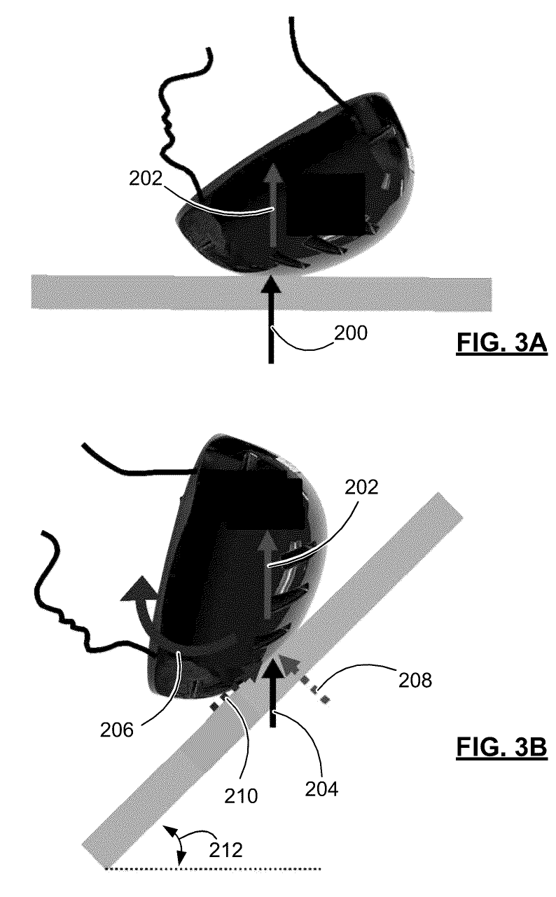

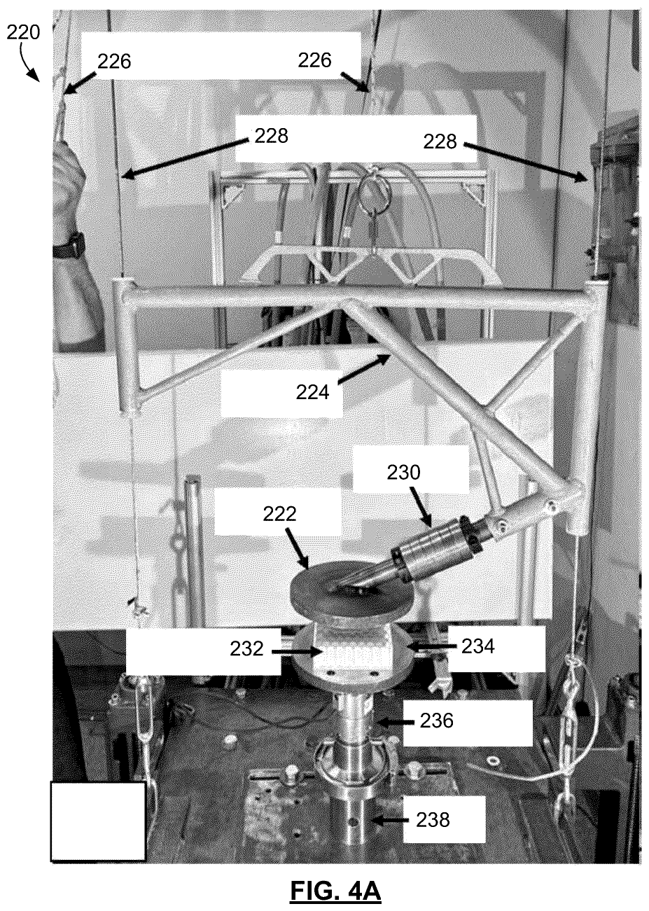

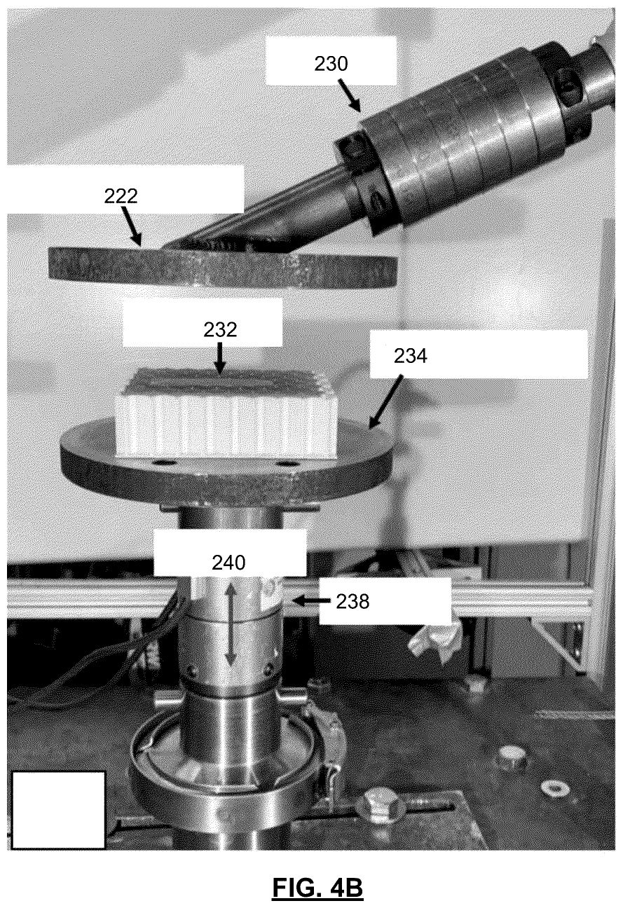

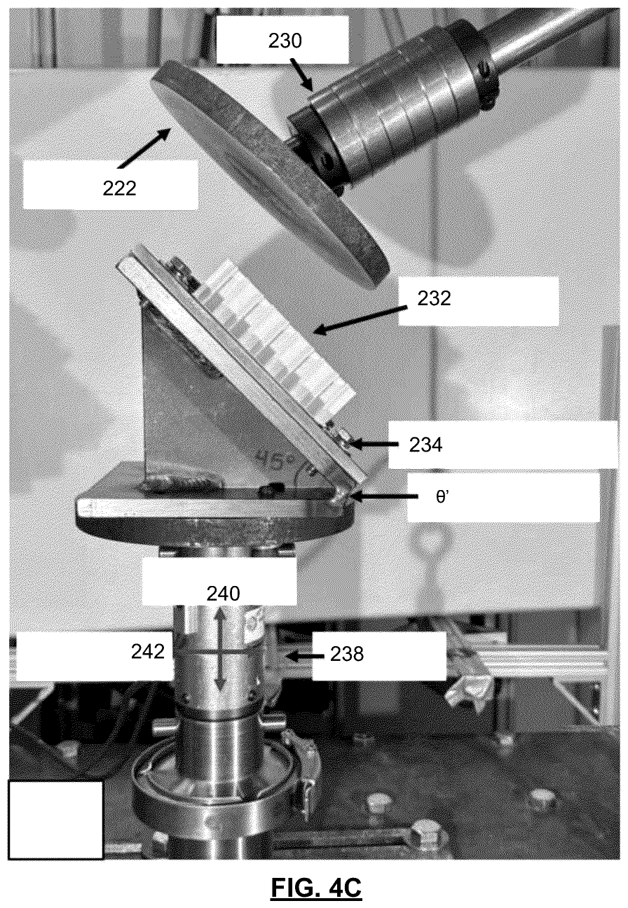

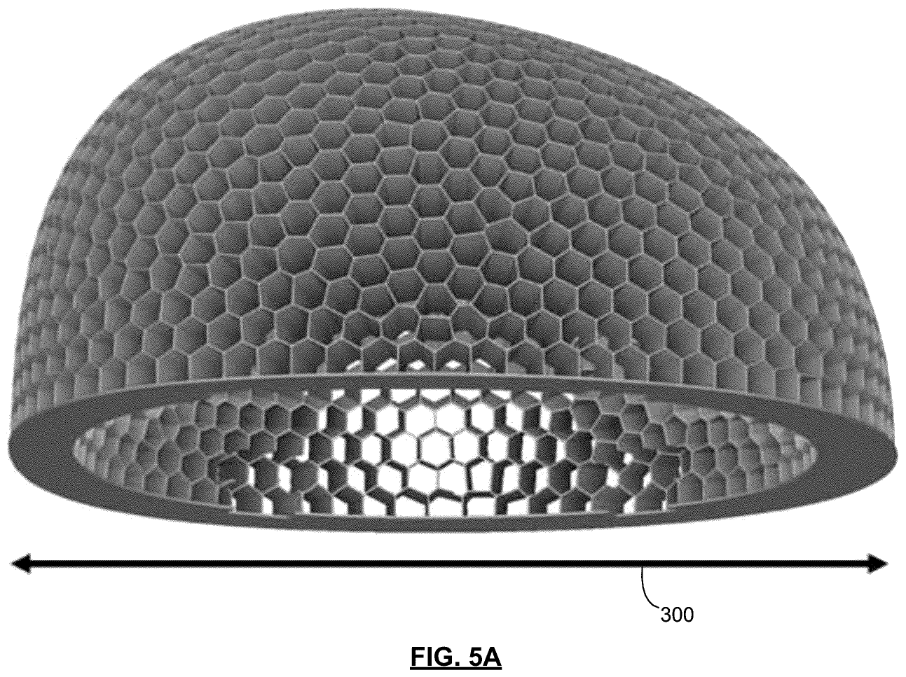

FIGS. 3A and 3B show loads and head motion in radial and oblique impacts. FIG. 3A shows a purely radial impact 200 causing linear motion 202 of the head. FIG. 3B shows an oblique impact 204 causing linear motion 202 and rotational motion 206 of the head. The oblique impact 204 (e.g., caused by linear motion of a sloped surface angled by angle 212) includes force in the radial direction 208 and in the tangential direction 210.

### Examples

The effectiveness of honeycomb and EPS foam was compared using dynamic drop tower tests at conditions seen in real-world bicycle accidents. First, small flat samples were tested to determine the effect of impact velocity and the effect of an angle compared to flat impact (combined loading versus pure compressive loading) on peak compressive stress, peak shear stress, and energy absorption per unit volume. Secondly, full-scale helmets of both honeycomb and EPS foam were compared for repeated flat and angled impacts to characterize differences in head kinematics and probability of sustaining a TBI, as well as to explore the potential reusability of the design.

### Small Scale Testing Examples

Honeycomb coupon samples with a target relative density (p) of 17% were generated in nTopology (New York, USA) and 3D-printed with thermoplastic polyurethane (TPU) filament, Ninjatek Cheetah (Ninjatek, Manheim, USA; density of 1.22 g/cm³, tensile strength 39 MPa, hardness 95 Shore A). The area of the coupon samples was 8840 mm², which was consistent with the average contact area in a helmeted bicycle accident. The thickness of the samples (25 mm) was chosen for consistency with typical EPS foam bicycle helmets. EPS foam samples with identical dimensions were obtained.

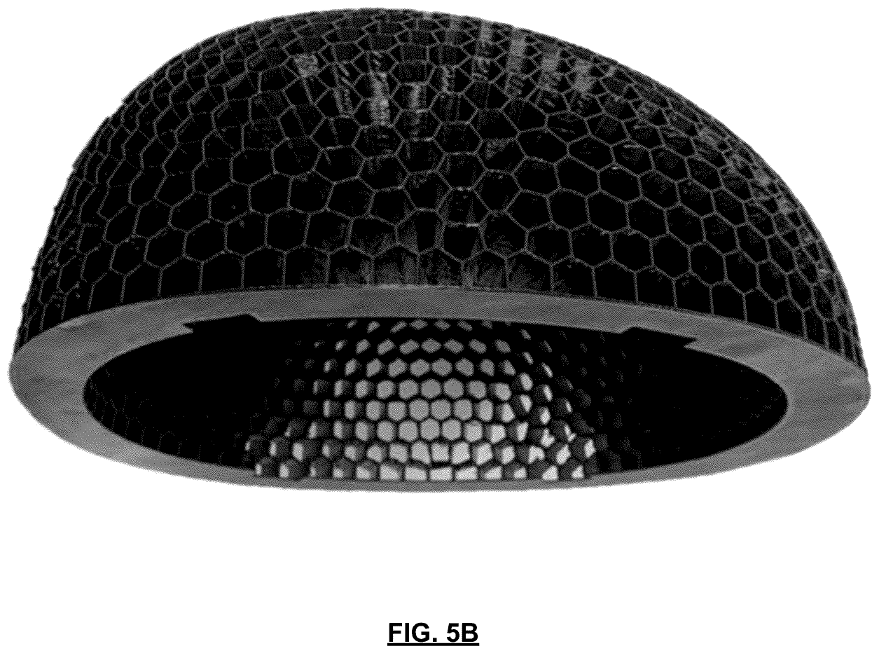

FIGS. 4A to 4C shows a small scale impact testing setup. The dynamic test setup consisted of a flat steel impactor mounted to a NOCSAE carriage, guided by two vertical wires and dropped onto the test sample, sitting on a platen and load cell. FIG. 4B shows the flat impact scenario with a horizontal platen and impactor, where load was measured in the Z-direction 240. FIG. 4C shows the angled impact scenario with a platen and impactor angled at θ=45°, where load was measured in the Z-direction 240 and X-direction 242.

In more detail, the test set up 220 consisted of a flat steel impactor 222 mounted to a National Operating Committee on Standards for Athletic Equipment (NOCSAE) carriage 224 (ballasted to 5.0 kg to mimic mass of the human head). A rope and pulley system 226 was used. Vertical guide wires 228 attached to the carriage 224. Weights 230 were also added to the carriage 224. A test sample 232 was placed on a platen 234 on a base 236, and a load cell 238 was used for sensing.

Three different impact scenarios were tested with three samples for each: i) slow (4.8 m/s) and flat (FIG. 4B), ii) fast (6.0 m/s) and flat, and iii) slow (4.8 m/s) and angled (45°, FIG. 4C). For impact scenarios i) and iii), tests were performed on both honeycomb and EPS foam samples to determine the effect of impact angle (e′) and material. For impact scenario ii), tests were performed on honeycomb samples only to determine the effect of impact speed on honeycomb behaviour. To secure the oblique samples to the angled platen they were glued on one side to an intermediate steel plate using either Loctite 414 cyanoacrylate (Henkel, Düsseldorf, Germany) or LePage epoxy (Henkel, Düsseldorf, Germany) for the honeycomb and EPS foam, respectively. For all scenarios, tests were performed consecutively three times on each sample to explore the potential for reusability of honeycomb and EPS foam.

A 6-axis load cell (IF-625, Humanetics Innovative Solutions, Plymouth, MI, USA) was mounted between the platen and the base. The output signals from the load cell were collected using a data acquisition system (PXIe-1082, National Instruments, Austin, Texas, USA) and custom-written LabVIEW® (National Instruments, Austin, TX, USA) program at a sampling rate of 50 KHz. A high-speed camera (MEMRECAM HX-3, nac Image Technology, Tokyo, Japan, 1024×520 pixel, 7,500 frames per second) was placed in line with the test sample to capture a series of images for all impacts.

Deformation of each sample and impact velocity for each test was determined from the high-speed camera footage. Load-deformation data were converted to stress-strain data based on initial sample dimensions, with compressive and shear forces resolved from the two axes of the load cell for angled impacts. The primary outcomes were peak compressive stress (σₚ), energy absorption per unit volume (Uᵥ), the integral of the stress-strain curve up to maximum deformation), and peak shear stress (τₚ).

Unpaired t-tests assuming equal variances were performed to detect differences between slow impacts on honeycomb versus EPS foam. To give adequate power, a two-way ANOVA was performed to detect any differences in average peak stress or volumetric energy absorption between slow and fast impacts, pooling the results for initial and repeated impacts. For flat platen tests, a two-way ANOVA was performed to detect differences between the first, second, and third impacts on honeycomb, pooling the slow and fast impacts. One-way ANOVAs were performed to detect differences between the first, second, and third impacts on EPS foam in the flat, slow impact scenario and in the angled impact scenario on both materials. For angled platen tests, t-tests were performed to identify differences between compression and shear, and between honeycomb and EPS. T-tests were also performed to detect differences in peak stress between flat and angled impacts for each material. A level of significance (α) of 0.05 was used in all statistical tests and post hoc Tukey tests were performed following all ANOVAs.

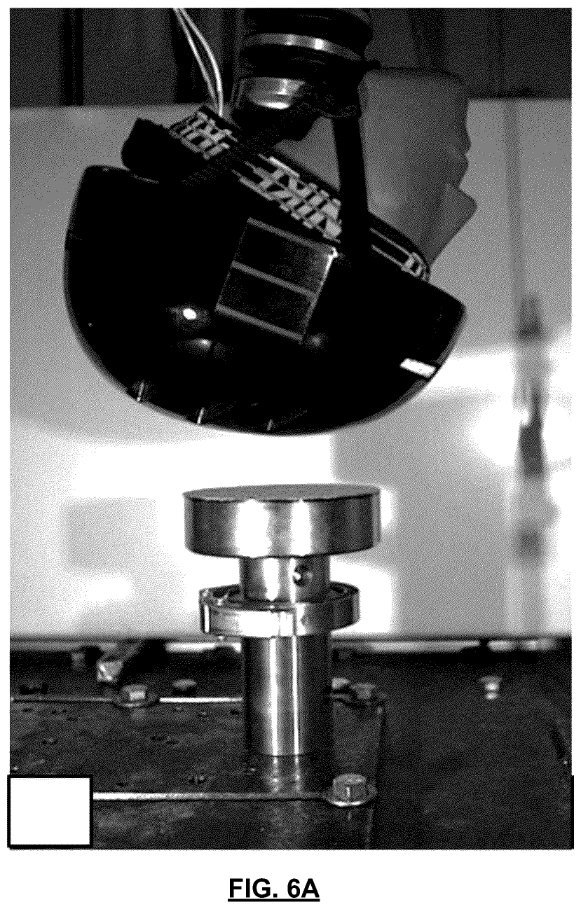

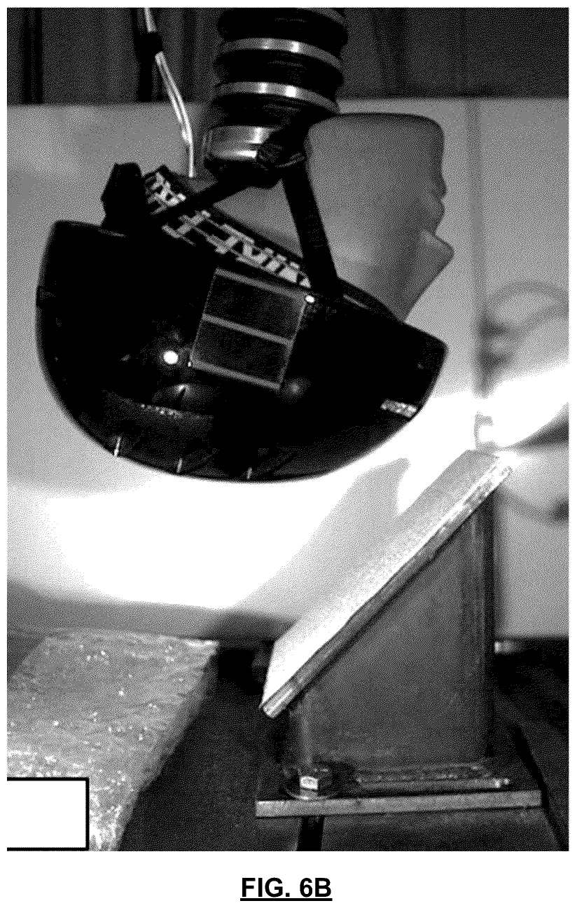

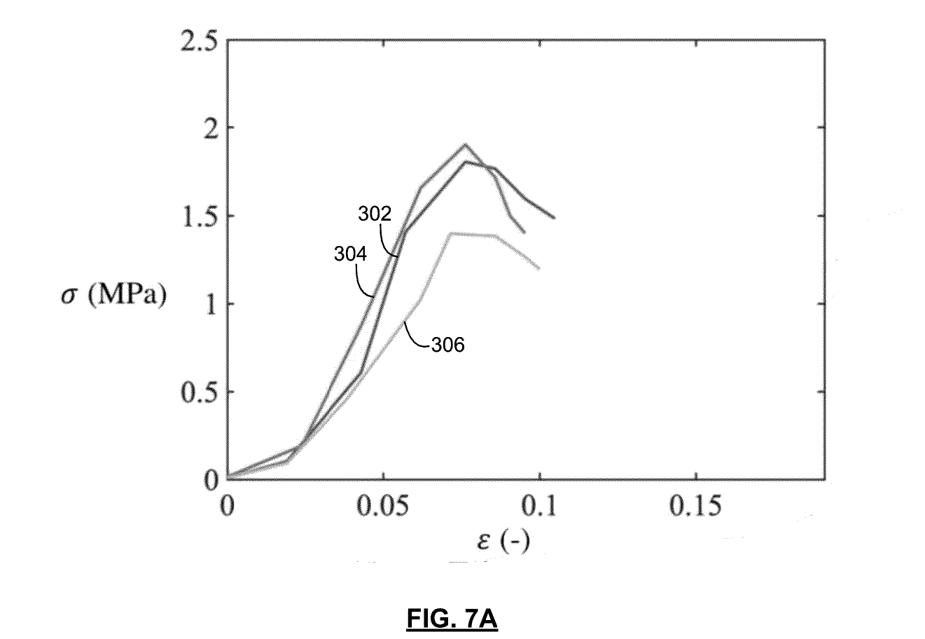

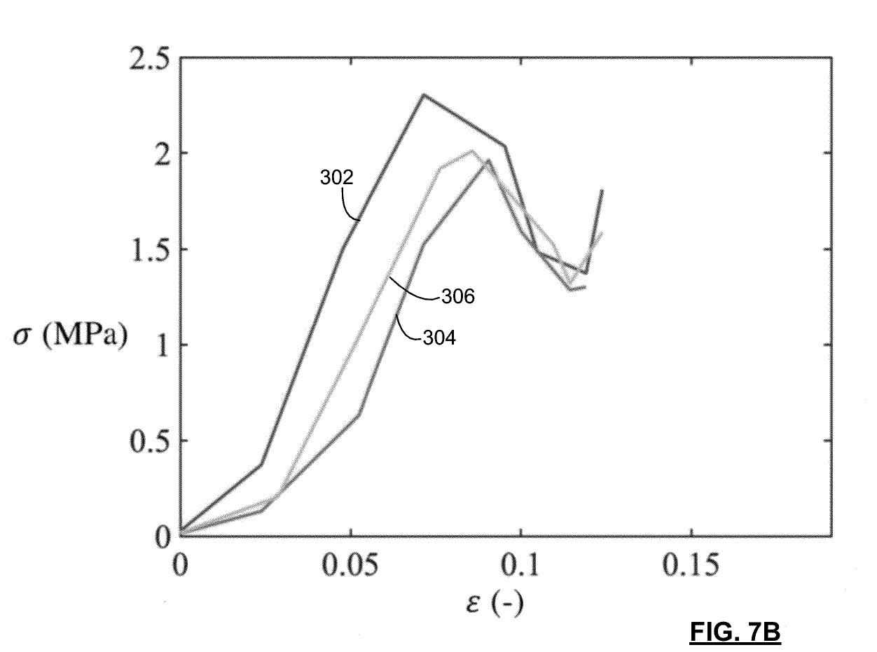

Regular honeycomb samples were 3D-printed with an average relative density of 16.2±1.1%. The average impact velocities were 4.85±0.09 m/s and 5.76±0.04 m/s for slow and fast impact scenarios, respectively. For the flat tests, honeycomb had a compressive peak stress of 1.71±0.21 MPa for the slow impacts, which was significantly lower than in the fast impacts (2.00±0.23 MPa, p=0.023). Volumetric energy absorption similarly increased with speed, at 0.093±0.01 kJ/mm³ for slow impacts and 0.135±0.02 KJ/mm³ for fast impacts (p=0.0005). (FIG. 6). At the slow, flat condition EPS foam had a 39% lower compressive peak stress than the honeycomb (p=0.01). Average volumetric energy absorption was 22% higher for EPS foam compared to honeycomb; however, this difference was not statistically significant (p=0.16).

Honeycomb samples failed through buckling of the cell walls, as observed in high-speed video. The amount of buckling was greater for the fast impacts, with all honeycomb samples returning to their original dimensions following impact (confirmed by measurement with calipers). Conversely, EPS foam failed through crack formation, and the thickness was permanently reduced following each impact by an average of 2.75 mm.

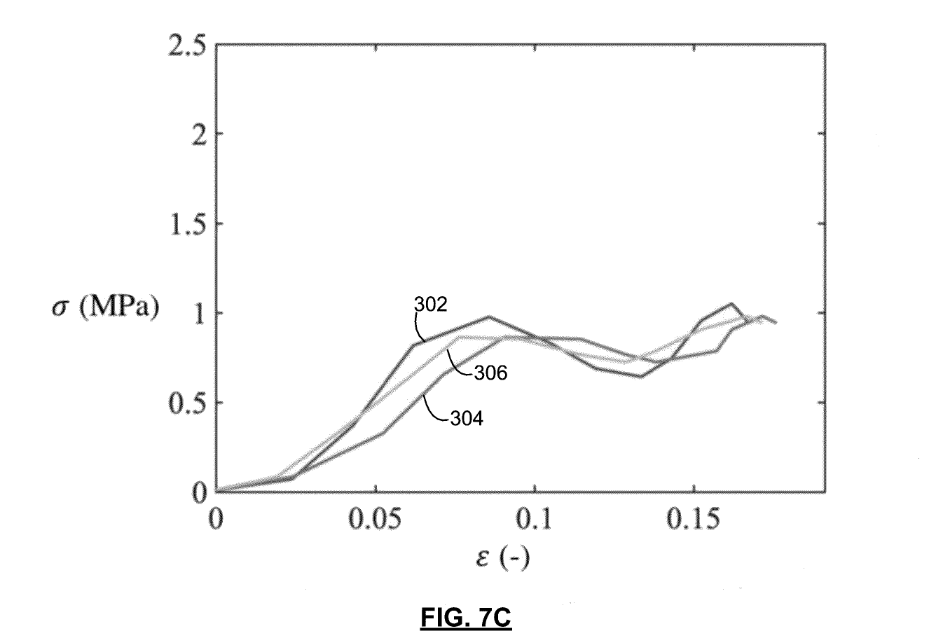

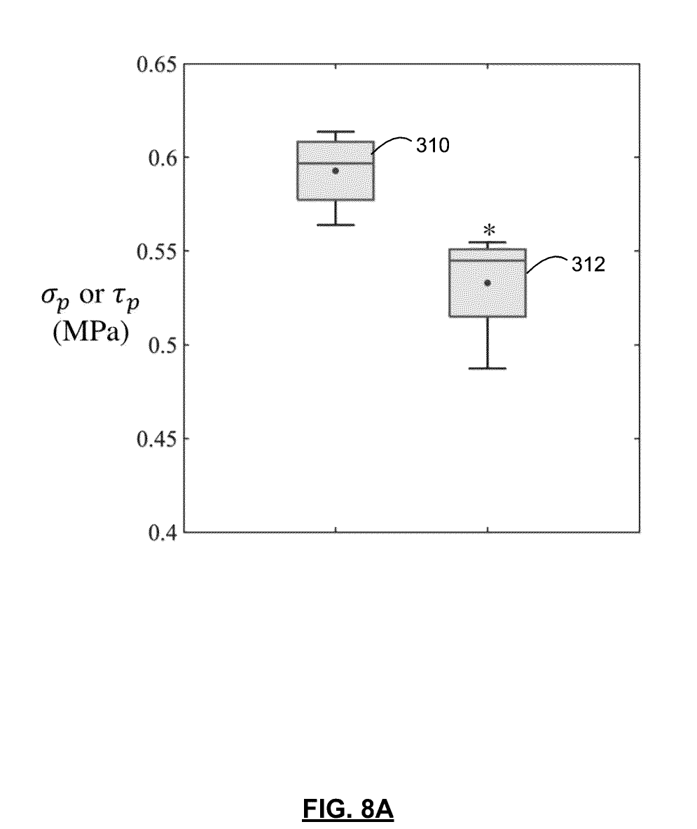

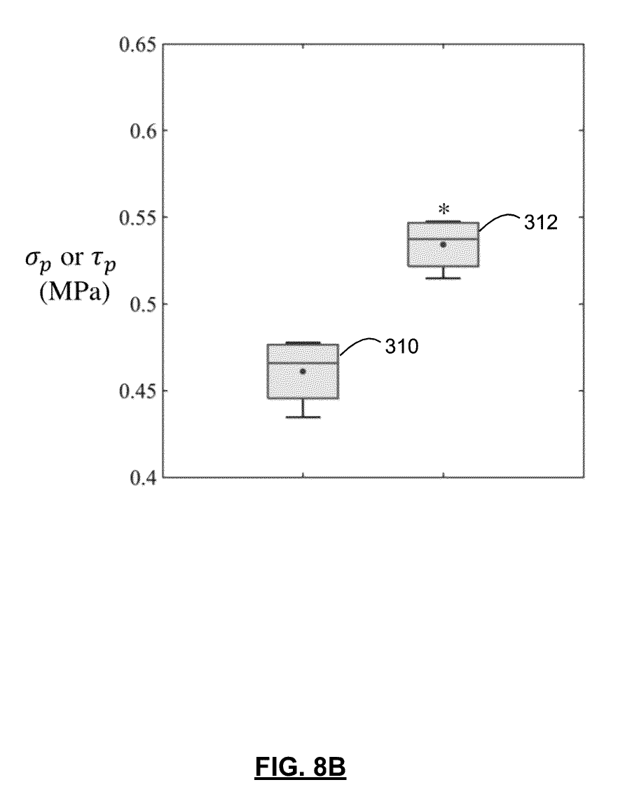

In the angled tests, there were significant differences in mechanical response between compressive and shear loading directions. For honeycomb samples, average shear peak stress was 10% lower than compressive peak stress (p=0.02) (FIGS. 7A to 7C). In comparison, for EPS foam samples shear peak stress was 16% higher than compressive peak stress (p=0.001). When comparing these results between the materials, the average compressive peak stress was 22% higher for honeycomb compared to EPS foam (p=0.0001); however, shear peak stress results were not different (p=0.94). Due to challenges in aligning the platen and impactor to be exactly parallel in the angled impacts, a uniform strain could not be measured, as such volumetric energy absorption was not presented. Honeycomb compressive peak stress was 66% lower for angled platen tests compared to flat platen tests (p=0.0002). Similarly, EPS foam compressive peak stress was 56% lower for angled platen tests compared to flat platen tests (p=0.00001).

The honeycomb samples showed good reusability. For flat honeycomb tests there were no significant differences in average compressive peak stress (p=0.62 between first and second impacts; and p=0.73 between first and third impacts) or volumetric energy absorption (p=1.0 between first and second; and first and third) among the three impacts when results for slow and fast impact scenarios were pooled. Similarly, for flat EPS foam tests there were no significant differences in compressive peak stress (p=1.0 between first and second impacts; and p=0.71 between first and third impacts) or volumetric energy absorption (p=0.26 between first and second impacts; and p=0.08 between first and third impacts) among the three repeated impacts. For angled anvil impacts, there were no significant differences in compressive peak stress (p=0.98 between first and second impacts; and p=0.89 between first and third impacts) or shear peak stress (p=0.97 between first and second impacts; and p=0.91 between first and third impacts) between the initial impact and repeated angled impacts for honeycomb. In comparison, compressive peak stress increased by 9% (p=0.01) and 14% (p=0.0008) between initial and second; and initial and third impacts, respectively. Shear peak stress increased by 9% (p=0.005) and 15% (p=0.0002) between initial and second; and initial and third impacts, respectively.

These examples demonstrate an effectiveness of a hexagonal honeycomb bicycle helmet design for impact mitigation and show the response of the material at velocities and energies representing real-world bicycle accidents, in conditions that apply both pure compression and combined compressive and shear loading-a critical scenario for robust protection. By using the exact same geometry, shell, straps and padding as the commercial EPS foam helmet, these examples show that differences noted may be attributed exclusively to the energy absorbing material. These examples show the honeycomb design enhances TBI protection over EPS foam, particularly due to its performance under shear loading.

For the small-scale test examples, the peak compressive and shear stress, and volumetric energy absorption results show that the energy absorbing structure reduce the risk of skull fracture, prevented densification in real-world impact severities, and provided sufficient deformation in shear to mitigate rotational head kinematics (and TBI). Results from the flat platen tests indicated that impact velocity had a significant effect on honeycomb compressive peak stress, highlighting the honeycomb's rate sensitivity. Due to a height limitation in the drop tower the fast condition did not match the target of 6.2 m/s, but the difference between speeds still allowed for characterization of the rate dependence while in the range of impact velocities seen in real-world accidents.

The examples show that densification did not occur in any samples during small-scale impacts. In some embodiments, this is an opportunity to reduce the strength of the honeycomb design. The examples also show the need to reduce the strength of the honeycomb design, since compressive peak stress was significantly higher for honeycomb compared to EPS foam, while the volumetric energy absorption achieved by the honeycomb samples was lower, due to the lesser degree of deformation experienced. It is important to note that in these tests the samples were flat, not curved like in a full-scale helmet, and this may have affected the results. This was however a necessary simplification to make for ease of 3D-printing and ensure accurate calculations of stress.

In angled impact tests on the honeycomb samples, shear peak stress was significantly lower than compressive peak stress, indicating the structure's anisotropy, as expected, and is desired for TBI protection. The lower shear strength is beneficial to achieve sufficient deformation to mitigate rotational head kinematics. On the other hand, shear peak stress was significantly higher than compressive peak stress for EPS foam, showing the limitations of EPS foam for head protection and the benefits of honeycomb as a replacement.

As in the flat platen tests, the compressive peak stress was significantly higher for honeycomb compared to EPS foam in the angled platen tests. There were no differences in shear peak stress between honeycomb and EPS foam, which indicated they would perform similarly for TBI protection, and reducing the strength of the honeycomb design to account for the strain rate dependence in some embodiments would make the honeycomb superior for TBI protection. In these examples, the volumetric energy absorption could not be calculated in the small-scale angled impact scenario because the platen and impactor were not precisely parallel, observed on high-speed camera footage after testing. However, the peak stresses (compressive and shear) could still be calculated, providing a meaningful assessment under these conditions. In some examples, the addition of precision alignment adjustments of the platen would facilitate this and provide an additional metric for assessment.

For the repeated impacts of the honeycomb, there were no differences in compressive peak stress, shear peak stress, or volumetric energy absorption in both flat and angled small-scale testing scenarios. Accordingly, in some embodiments the design would be reusable for multiple impacts without requiring replacement. Compressive peak stress for EPS foam was not different among repetitions in the flat platen impact scenario; however, an increasing trend was observed, and may have reached significance with a larger sample size. Volumetric energy absorption for EPS foam was also not significantly different among repetitions but it should be noted that the volume was adjusted for the reduced thickness of the sample following each test, compensating for the residual deformation present. For angled platen tests, compressive peak stress and shear peak stress increased significantly among impact replications due to plastic deformation in the form of crack propagation, highlighting the need to replace EPS foam bicycle helmets following an accident.

Overall, the small-scale testing examples show that embodiments of the honeycomb-style structure is beneficial for bicycle helmets in comparison to EPS foam, due to its anisotropy that allows sufficient deformation in the shear loading direction. The rate sensitivity of the design was also highlighted and showed that in some embodiments a design modification can be used. In some embodiments, the relative density of the honeycomb design is reduced to be more suitable for impact mitigation under real-world conditions. A limitation of the scaling method was that the relationship between compressive peak stress and relative density was assumed to follow the same trend for all impact velocities. This simplification was necessary to reduce the number of samples required for dynamic impact testing, but multiple relative densities could be tested under dynamic loading to select an appropriate amount in some embodiments. Impact velocity effects were only considered in the normal loading direction—it was assumed that impact rate would have a similar effect in pure shear loading and combined loading scenarios. The reduction in relative density had direct implications to skull fracture protection, ensuring the compressive strength of the honeycomb would not exceed the fracture strength of the human skull. Lowering the relative density in some embodiments also leads to benefit in the outcome in terms of TBI protection by allowing a greater level of deformation in shear loading to mitigate rotational head motion.

### Full Scale Testing Examples

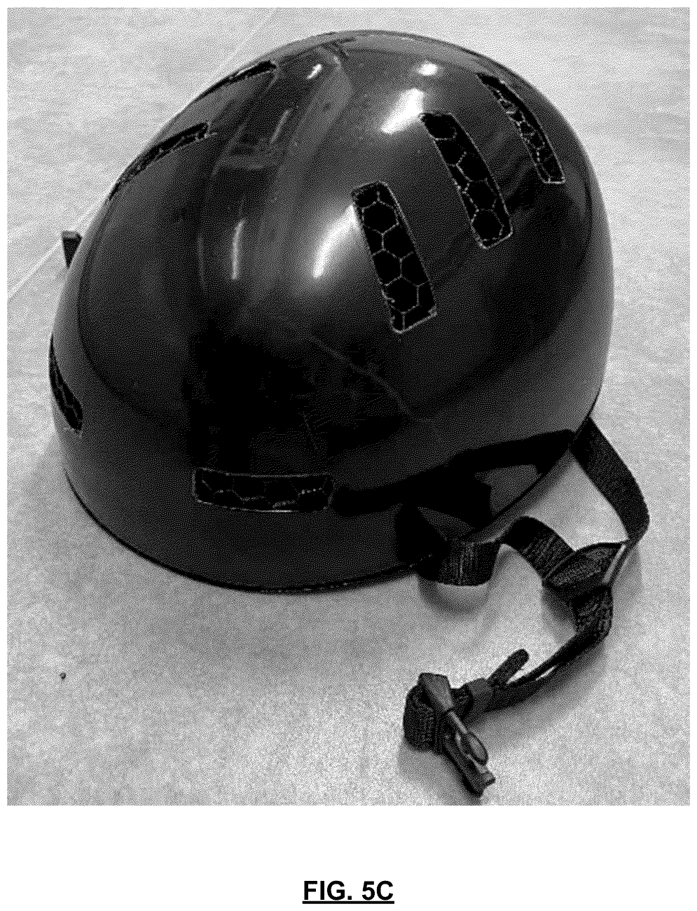

FIGS. 5A to 5C show a honeycomb helmet design and isometric view of the full-scale honeycomb helmet. FIG. 5A shows a model with an overall length 300. FIG. 5B shows a prototype energy absorbing component. FIG. 5C shows an assembled product.

FIGS. 6A and 6B show a full-scale impact testing setup. Each helmet was secured to a Hybrid III ATD head and neck mounted to a NOCSAE carriage, dropped from an initially vertical orientation. FIG. 6A shows the flat impact scenario. FIG. 6B shows the angled impact scenario (θ=45°).

Based on the results from small-scale testing and previous quasi-static compression testing, the honeycomb was found to be rate sensitive under dynamic conditions. As such, a scaling factor was determined by the ratio of dynamic peak stress to quasi-static peak stress for a constant known relative density. Using the scaling factor, a power regression relationship between compressive peak stress and relative density of the honeycomb structure was predicted for an impact velocity of 4.8 m/s. The static peak stress that corresponded to a relative density of 17% (which was determined to be the most suitable relative density in quasi-static conditions) was found. Using the power regression relationship and this static peak stress, a new desired relative density was of 11.4% was predicted to be most suitable for the 4.8 m/s impact condition and therefore this was the target relative density for full-scale honeycomb helmet prototypes.

The shape of the full-scale helmet was based on a large adult Seven Star Sports™ (Hamilton, Ontario, Canada) multi-sport helmet, which consisted of an EPS foam layer, an outer polyvinyl chloride (PVC) shell, a retention system, a strap, and comfort padding. The CAD model of the honeycomb was designed to have the same external dimensions as the original EPS foam liner, but with ventilation holes removed as the honeycomb cells served as air vents. This helmet model was imported to nTopology™ (New York, USA), where the outer helmet surface was extracted, and a set of 1000 random points was generated on the surface. To create the honeycomb pattern, a Voronoi boundary lattice was generated from the set of random points, which was subsequently extruded into a 3D honeycomb structure and the cell walls thickened to 0.91 mm to achieve the desired relative density. Finally, a brim was added to enclose the bottom surface, and a mesh generated (FIG. 5A). A Raise3D™ (Irvine, California, USA) Fused Deposition Modelling™ (FDM) 3D-printer was used to manufacture the full-scale honeycomb helmets (N=5) (FIGS. 5B and 5C). Flexfill TPU™ (Fillamentum Addictive Polymers™, Hulín, Czech Republic; density 1.23 g/cm³, tensile strength 53.7 MPa, hardness 98 Shore A) filament was used. The helmet was printed with the brim flat on the print bed, and with a support structure in the centre-most part of the helmet to support areas with large overhangs (removed after printing). PVC shells, straps and padding identical to those from the multi-sport helmet were added and secured using cyanoacrylate. Five of the corresponding EPS helmets were obtained for comparative purposes.

Impact testing was performed using the same NOCSAE drop tower as described above for the small-scale tests. In turn, each helmet sample was applied to a Hybrid III 50th percentile male head-and-neck Anthropomorphic Test Device™ (ATD™, Humanetics Innovative Solutions™, Plymouth, MI, USA), with a polyester/spandex skull cap covering the headform to mimic hair friction. The total drop mass was 7.96 kg including the mass of the ATD™ head, ATD™ neck, neck adapter, and carriage. Impacts were applied by dropping onto a steel platen, covered with 80-grit sandpaper, in accordance with ECE R-22.05™, to mimic a real-world impact surface. Two scenarios were tested: i) crown impact (on flat platen FIG. 6A), and ii) frontal oblique impact at 45° (on angled platen, FIG. 6B), both at 4.8 m/s to represent real-world accidents and for consistency with previous studies. Each helmet was subjected to three drops at its assigned test conditions to investigate the reusability of the designs.

The Hybrid III ATD™ headform was instrumented with a 6-axis accelerometer (6DX PRO™, DTS™, Calabasas, California, United States) to measure the linear and rotational kinematics of the headform, collected at a frequency of 20 KHz and filtered with a CFC180 filter. The primary kinematic outcomes were peak resultant linear acceleration (αₚ), peak y-axis rotational acceleration (sagittal plane) (αₚ), and peak y-axis rotational velocity (sagittal plane) (ωₚ). The likelihood of sustaining a head injury was measured by the 15 ms Head Injury Criteria™ (HIC15™). The probability of sustaining a TBI with an Abbreviated Injury Score of 2 (P(AIS2)™) was calculated based on the Brain Injury Criteria™ (BrIC™) for rotation of the head in the sagittal plane. Kinematic response, HIC15™, and BrIC™ were compared between honeycomb and EPS helmets. Unpaired t-tests assuming equal variances were performed to detect differences in each kinematic parameter between the EPS foam helmets and the honeycomb helmets. One-way ANOVAs were performed to detect differences between the first, second, and third impacts on each helmet type. A level of significance (α) of 0.05 was used in all statistical tests and post hoc Tukey tests were performed following all ANOVAs.

A scaling factor of 2.3 was determined from a quasi-static loading condition to a 4.8 m/s dynamic loading condition. According to the power regression relationship for quasi-static loading, a peak stress of 0.78 MPa would correspond to a honeycomb relative density of 17%. A relative density of 11.4% was found to correspond to 0.78 MPa for an impact velocity of 4.8 m/s. Therefore, full-scale honeycomb helmet prototypes were 3D-printed with a relative density of 11.4%. The average mass of the honeycomb helmets was 463±7.5 g and the average mass of the EPS foam helmets was 300±1.9 g.

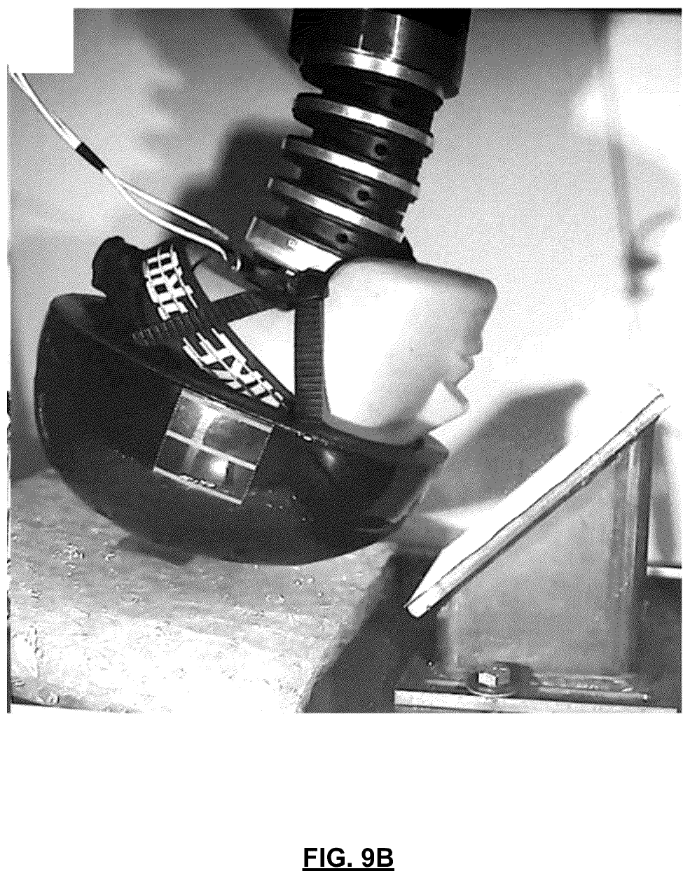

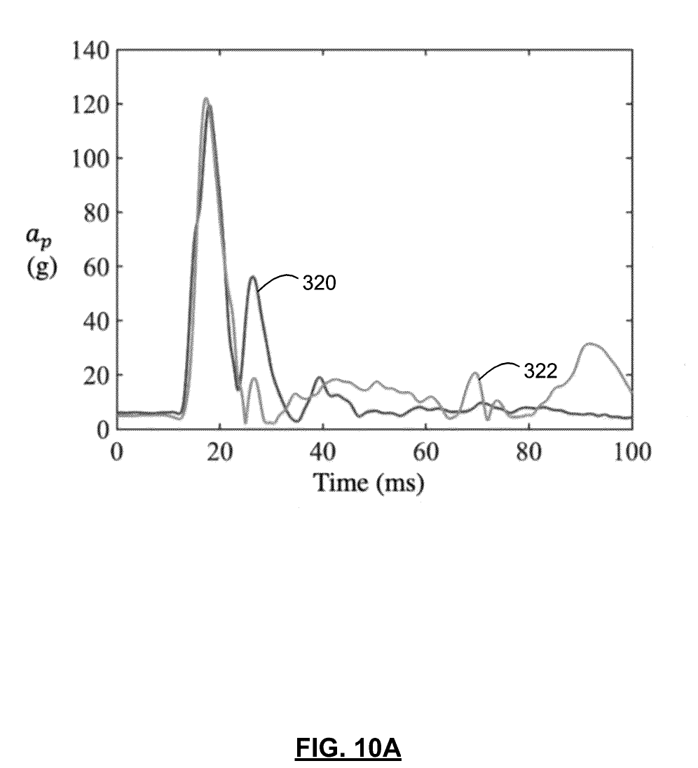

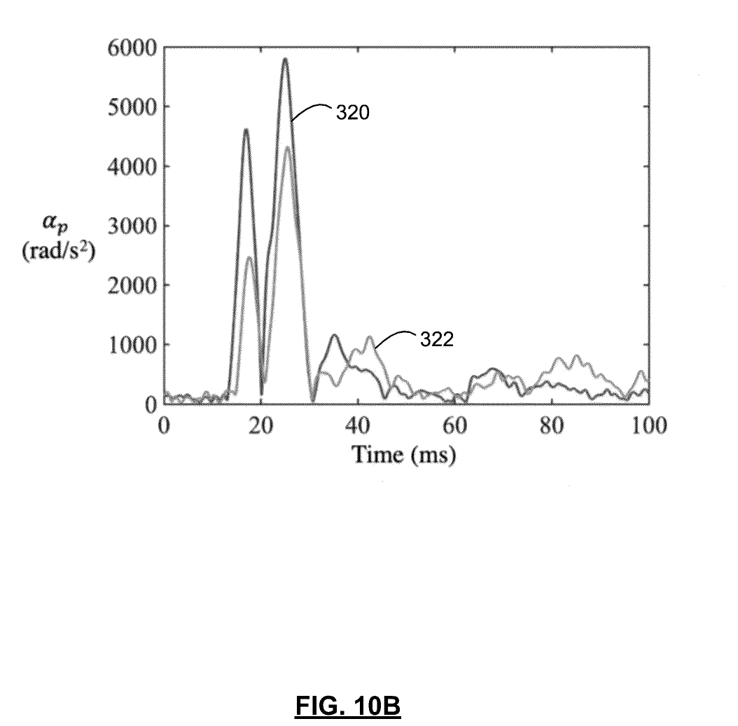

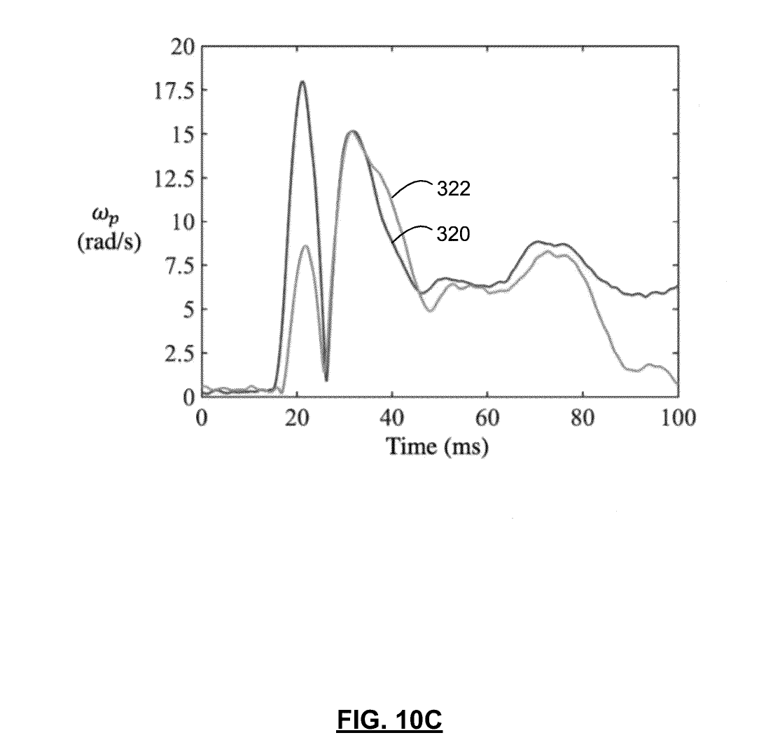

The average impact velocity for all initial (first) impacts was 4.85±0.2 m/s on the flat anvil, and 4.75±0.1 m/s on the angled one. For oblique impacts there were two phases of motion observed-flexion of the neck, followed by extension (FIGS. 9A and 9B). These phases corresponded to two peaks in head kinematics (FIGS. 10A to 10C), where only the first peak was used for analysis.

Head kinematics for the initial impact were grouped by helmet and test type, including peak linear acceleration (αₚ), peak rotational acceleration (αₚ), and peak rotational velocity (@p); and head injury risk metrics including HIC15, and P (AIS2) based on BrIC (Table 1). For the flat impact scenario, honeycomb helmets had a 5% higher impact velocity, 34% higher αₚ, and 7% lower HIC15 than EPS foam helmets. For the angled impact scenario, honeycomb helmet tests had a 1% lower impact velocity (p=0.68), and there was no difference in ay when compared to EPS foam helmets (p=0.8). However, HIC15 was 30% lower for honeycomb helmets compared to EPS foam helmets (p=0.005). Metrics based on rotational acceleration also highlighted increased protection from honeycomb helmets, with a 40% lower αₚ (p=0.006), 11% lower ωₚ (p=0.2), and 28% lower P (AIS2) (p=0.2) compared to EPS foam helmets.

TABLE 1
Drop tower test results for initial impacts. Key metrics of peak linear
acceleration (aₚ), Head Injury Criteria (HIC15), peak rotational acceleration
(αₚ), peak rotational velocity (ωₚ) and probability of AIS2 injury
based on BrIC (P(AlS2)) from the ATD head were calculated for the flat
(N = 2 per group) and angled (N = 3 per group) conditions. No
p-values are reported for flat anvil tests due to the small sample size.

| | | EPS FOAM | | HONEYCOMB | | |
|---|---|---|---|---|---|---|
| | | Avg. | St. Dev. | Avg. | St. Dev. | P-value |
| FLAT | Velocity (m/s) | 4.74 | 0.16 | 4.96 | 0.12 | — |
| ANVIL | aₚ [g] | 137 | 0.4 | 184 | 1.3 | — |
| | HIC15 | 254 | 15 | 237 | 16 | — |
| ANGLED | Velocity (m/s) | 4.77 | 0.10 | 4.73 | 0.08 | 0.68 |
| ANVIL | aₚ [g] | 121 | 9.0 | 120 | 3.8 | 0.8 |
| | HIC15 | 395 | 31 | 277 | 17 | 0.005* |
| | αp [rad/s²] | 4356 | 577 | 2578 | 97 | 0.006* |
| | ωₚ [rad/s] | 18 | 2.3 | 16 | 0.70 | 0.2 |
| | P(AIS2) | 18 | 5.8 | 13 | 1.5 | 0.2 |

For the three repeated tests on each helmet, the average impact velocity was 4.9±0.2 m/s on the flat anvil, and 4.76±0.2 m/s on the angled one. For flat anvil impact tests, the EPS foam helmets showed damage from repeated tests, with peak linear acceleration increasing by 12% and 20% from the initial impact to the second and third impacts, respectively. In comparison, protective capacity was maintained for honeycomb helmets, whereby peak linear acceleration decreased by 1% and 5% from the initial impact to the second and third impacts, respectively. For angled anvil impact tests, the EPS foam helmets showed a similar increase in peak linear acceleration (24% from initial to third impact, p=0.03), but no significant differences were noted in peak rotational acceleration or velocity between initial and repeated impacts. In comparison, for honeycomb helmets, there was a significant decrease in peak rotational acceleration by 21% between the initial and second impacts (p=0.045); and initial and third impacts (p=0.01). There were no significant differences in peak linear acceleration or peak rotational velocity between initial and repeated impacts.

FIG. 7A to 7C show the stress-strain results for flat platen impact tests, including a line for sample 1 at 302, a line for sample 2 at 304, and a line for sample 3 at 306. FIG. 7A shows stress-strain curves for a flat platen impact test for honeycomb under the slow impact condition (4.85 m/s). FIG. 7B shows stress-strain curves for a flat platen impact test for honeycomb under the fast impact condition (5.76 m/s). FIG. 7C shows stress-strain curves for a flat platen impact test for an EPS foam under slow impact condition (4.85 m/s).

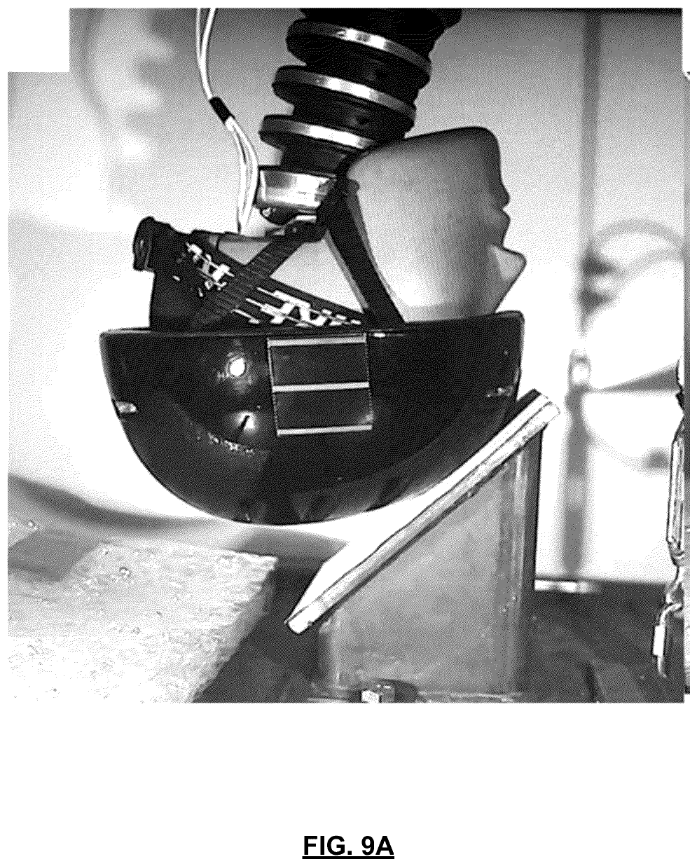

FIGS. 8A and 8B show the peak stress results for compressive loading at 310 and shear loading at 312. Average stress results are shown for angled platen impact tests. FIG. 8A shows compressive stresses in honeycomb were higher than shear stresses. FIG. 8B shows compressive stresses in EPS were lower than shear stresses. An asterisk (*) shows a significant difference from compressive stress (p<0.05).

FIGS. 9A and 9B show head and neck motion in angled anvil impacts. The motion of the headform and neck are shown in the sagittal plane where there are two phases, including neck flexion shown in FIG. 9A and neck extension shown in FIG. 9B.

FIGS. 10A and 10B show an example of kinematic responses for each helmet type. Kinematic response-time curves are shown for one EPS foam helmet at 320 and one honeycomb helmet at 322 in the angled impact scenario, where FIG. 10A shows linear acceleration (αₚ), FIG. 10B shows rotational acceleration (αₚ), and FIG. 10C shows rotational velocity (ωₚ).

When moving to full-scale helmet testing examples, the material used was changed. This was necessary for compatibility with a large-volume 3D printer but may have introduced some differences from the previous small-scale coupon test examples. The filament used for full-scale prototypes had a 1% higher density, 38% higher tensile strength, and 3% greater hardness. Using the same helmet shell, straps and padding as the EPS helmets allowed an isolated investigation into the capabilities of the honeycomb design. Results from full-scale helmet testing suggested that the honeycomb energy attenuation system developed herein was effective at protecting against both linear and oblique impacts. The honeycomb helmets had a 54% higher mass than the EPS foam helmets. This likely contributed to the higher accelerations noted in the flat anvil tests. However, in oblique tests the honeycomb helmets had better protection against TBI (angular acceleration was 41% lower than EPS helmets). In some examples, the honeycomb design relative density is reduced to positively impact all performance metrics. In some embodiments, this also reduces the weight of the honeycomb helmet, which is beneficial for both comfort and injury mitigation.

The magnitude of linear acceleration for EPS foam helmets was higher (121 g) compared to results from previous studies (65-82 g) for impacts on a 45-degree anvil with a 4.8 m/s target impact velocity. The magnitude of rotational acceleration and velocity for EPS foam helmets was lower (4356 rad/s² and 18 rad/s) compared to results from previous studies (6237-7336 rad/s² and 20-23 g). The percent decrease in rotational acceleration from EPS foam to honeycomb helmets (40% reduction) was in the range of the reduction provided by WaveCel™ helmets (15%-73%) according to previous studies for impacts on a 45-degree anvil with a 4.8 m/s target impact velocity. However, WaveCel™ helmets provided increased reduction in rotational velocity from EPS foam helmets (45%-73%) compared to the results for honeycomb helmets.

Both the EPS foam and honeycomb helmets would have passed helmet certification standards that require the linear acceleration of the headform to remain under 250 g for flat anvil impacts with a target impact velocity of 4.8-6.2 m/s. It must be noted that the test setup used herein was not directly representative of these test standards, where an ATD neck is not used, and the impact mass is lower (5.0 kg). The Hybrid III™ head used in this study was designed and validated for frontal automotive collision tests. However, it has been used previously in oblique bicycle helmet testing, and among ATD heads available, the Hybrid III™ has the most realistic head mass (4.5 kg), skin, and inertial properties. As well, the Hybrid III™ neck was used in this study as its use has been noted to lead to more realistic rotational head kinematics. However, the Hybrid III™ neck is substantially stiffer than the human neck in all directions of rotation, which may influence laboratory test results. As well, the high rotational accelerations seen in the extension phase using the Hybrid III™ neck (FIG. 8B) are not present with activated neck muscles and may be caused by the storage of rotational energy from the flexion phase in the rubber material. As such this second peak was not considered in analysis.

Testing conducted herein did not explore all possible scenarios for injury, as it focused on a limited set of impact conditions (speeds, angles, and frontal location only). This was to best represent the most common real-world bicycle accident conditions, but the protective capabilities of the honeycomb helmet for lateral and occipital impact locations under a variety of speeds and angles is also contemplated. The flexibility of 3D printing is a significant advantage towards this optimization process. In some embodiments, the design is tuned to provide the greatest protective capabilities.

The behaviors of honeycomb and EPS foam were explored through small and full-scale drop tower testing under dynamic pure compressive and combined loading scenarios. The new elastomeric honeycomb helmet design showed improved protection against TBI while providing sufficient protection against skull fracture. These examples show the honeycomb helmet is a new option for better protection against both normal and oblique loading of the head during bicycle accidents.

It will be appreciated that numerous specific details are set forth in order to provide a thorough understanding of the example embodiments described herein. However, it will be understood by those of ordinary skill in the art that the embodiments described herein may be practiced without these specific details. Furthermore, this description and the drawings are not to be considered as limiting the scope of the embodiments described herein in any way, but rather as describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies. It should be noted that the term “coupled” used herein indicates that two elements can be directly coupled to one another or coupled to one another through one or more intermediate elements.

Various embodiments have been described herein by way of example only. Various modification and variations may be made to these example embodiments without departing from the spirit and scope of the invention, which is limited only by the appended claims.

1. An impact protection structure, comprising:
a sheet formed of a plurality of polygonal cells adjacent one another, the plurality of polygonal cells including a plurality of hexagonal cells, the plurality of polygonal cells including at least one pentagonal cell and at least one heptagonal cell to accommodate a generally domed shape in the sheet with a reduction in a distortion of a regular shape of the plurality of hexagonal cells.

2. The structure of claim 1, wherein the sheet has a first surface and a second surface opposite the first surface, and the polygonal channels each open through the first surface at a first end of the channel and open through the second surface at a second end of the channel.

3. The structure of claim 2, wherein each polygonal channel has a common number of sides at each of the first and second ends of the channel.

4. The structure of claim 1, wherein the sheet includes at least one pentagon-heptagon cell set comprising a pentagonal cell adjacent a heptagonal cell.

5. The structure of claim 14 wherein the plurality of polygonal cells include a plurality of pentagonal cells and a plurality of heptagonal cells, and each of the at least one pentagon-heptagon cell set comprises one or more pentagonal cell and one or more heptagonal cell.

6. The structure of claim 5, wherein the sheet includes a plurality of pentagon-heptagon cell sets separated from one another by hexagonal cells.

7. The structure of claim 6, wherein the pentagonal cells and the heptagonal cells occur in the sheet only in the pentagon-heptagon cell sets.

8. The structure of claim 1, wherein the sheet is an elastomeric sheet.

9. The structure of claim 1, wherein the structure is a single generally domed shape.

10. Use of the impact protection structure of claim 9 in a helmet.

11. The structure of claim 1, wherein the plurality of polygonal cells consists of central cells each surrounded by other polygonal cells and edge cells bordering a free edge of the sheet, and the central cells each comprise at least five sides.

12. The structure of claim 11, wherein at least 75% of the central cells are hexagonal cells.

13. An impact protection structure, comprising;
a matrix of a plurality of generally planar sidewall segments joined together at lengthwise ends thereof to form a central portion of a sheet having a first surface and a second surface opposite the first surface, each segment extending from the first surface to the second surface and separating adjacent cells whereby the matrix defines a plurality of polygonal cells adjacent one another, and
wherein the plurality of polygonal cells includes a plurality of hexagonal cells and at least one pentagonal cell whereby a generally domed shape in the sheet is accommodated with a reduction in a distortion of a regular shape of the polygonal cells.

14. The structure of claim 13, wherein each sidewall segment has a width between adjacent cells, and the width is generally constant between the first and second surfaces.

15. The structure of claim 13, wherein each sidewall segment has a width between adjacent cells, and the widths of the plurality of generally planar sidewall segments are all generally equal to a common width.

16. The structure of claim 13, wherein each sidewall segment has a width between adjacent cells and the width of each sidewall segment is generally constant along the height of the sidewall segment.

17. The structure of claim 13, wherein each sidewall segment has a length between the ends thereof, and the lengths of the plurality of generally planar sidewall segments are all within a variation of 25% of a predetermined length.

18. The structure of claim 13, wherein the plurality of polygonal cells each have a transverse area at the first surface that is within a variation of 25% of a predetermined area.

19. The structure of claim 13, wherein the plurality of generally planar sidewall segments are formed of an elastomeric material.

20. The structure of claim 13, wherein the impact protection structure is a generally domed shape for use in forming a protective layer in a helmet.
